(19) United States
(12) Patent Application Publication
(10) Pub. No.: US 2006/0087432 A1
(43) Pub. Date: Apr. 27, 2006

(54) Automatic luggage tracking system

(76) Inventor: Bradford G. Corbett JR., Fort Worth, TX (US)

Correspondence Address: Charles D. Gunter, Jr.;Whitaker, Chalk, Swindle & Sawyer, LLP, 3500 City Center Tower II, 301 Commerce Street, Fort Worth, TX, 76102-4186, US

(21) Appl. No.: 10/970,603

(22) Filed: Oct. 21, 2004

(51) Int. Cl. G08B 13/14; G05B 19/00; G06Q 30/00; G08B 1/08

(52) U.S. Cl. 340/572.1; 340/539.13; 340/539.23; 340/5.92; 235/385

(57) ABSTRACT

A monitoring and location system for mobile objects is shown for monitoring the presence or absence of items of personal value packed by a traveler within a suitcase or other item of luggage which away from home on a trip. Each item of personal value is provided with an electronic signally device or chip, such as a separate RFID tag, which has a unique electronic indicia stored thereon for transmission by a radio frequency signal upon request from an RFID interrogation unit. The interrogation unit is mounted on the interior of the item of luggage and monitors the presence of each RFID tag as the item of personal value is placed within the item of luggage.

### BACKGROUND OF THE INVENTION

1. Field of the Invention

The present invention relates generally to the field of object tracking and, more specifically, to a system for keeping track of personal items of value which are packed in an item of luggage during travel through the use of electronic signaling technology such as radio frequency identification (RFID) technology.

2. Description of the Prior Art

An item of personal value, in the context of this application, is any object that is deemed of value to a person including objects which have inherent intrinsic worth, in addition to objects having a fixed monetary value. For example, the object in question could be a timepiece of sentimental importance or could comprise books, jewelry, clothing, electronic devices, a passport, etc. Many items of personal value are left behind and lost each year by travelers who leave such items behind in hotel and motel rooms, or in airports or on buses, trains and the like. A need exists for a system for monitoring or tracking personal items of value which are packed in a suitcase or other piece of luggage while away from home on a trip.

Various types of object tracking schemes are know in industry. For example, organizations such as Federal Express and the U.S. Postal Service typically utilize scannable barcodes that are attached to packages containing valuables. Procedurally, the barcode on the package is first scanned before it leaves the premises of these organizations, and thereafter its location is recorded at various predetermined locations during its course of travel. There are certain disadvantages to bar code systems: because they are optical, obscuring of the label (or of the bar code reader lens) by exposure to dirt, dust, water, ink, or paint will make the label unreadable. Furthermore, ink bleeding, stray marks, dropouts, label warping, and label tearing are problems with bar code labels, especially when the label must stay in place and be readable for several years. A further problem is that bar codes can be copied through mechanical means such as photocopying. In addition, bar coded information cannot be erased, rewritten, or appended.

U.S. Pat. No. 5,708,423 discloses a data processing system that automatically maintains records of respective locations of a plurality of objects in real-time. Each of the objects has secured thereto a respective object marker which transmits an identification signal that is unique to the respective object. Each sensor device, installed at doorways of a building, receives the identification signal transmitted from the object marker as the respective object is moved through the doorway.

U.S. Pat. No. 6,097,301 discloses an RF identification system for identifying objects by communication between a RF transceiver, mounted on each object, and a RF receiver. An interrogating receiver is mounted on the human operator.

The use of printed or written identification tags is probably the most well known and prevalent method for monitoring objects of personal value by travelers. For example, tags may be placed on luggage, cell phones, computer equipment, or any object capable of being lost, and making it possible for the finder to locate the owner to arrange for the return of the item.

Traditional identification tags have certain disadvantages, however. For example, they reveal the owner's name, address, and possibly phone numbers, causing loss of privacy and security risks. Many owners will not use identification tags which reveal their true names, etc., because the risk of that information being discovered and misused.

The idea of electronically encoding the owner's private information on an identification tag has been proposed by others, but prior methods require registering the encoded information with a third party, and for the finder to return the lost object to the third party who, in turn, returns the lost object to the owner.

It would be preferable to provide a system for travelers which prevents the item of personal value from being lost in the first place.

It would be preferably to provide a system for travelers which electronically records items which are being packed in a suitcase or other piece of luggage, which system also verifies that all such recorded items are again present in the piece of luggage when the traveler begins the return trip home.

Preferably such an item monitoring system would use an unobtrusive electronic system for recording and verifying the presence of items of value in a piece of luggage which would eliminate many of the disadvantages associated with bar code type systems. Most preferably the unobtrusive electronic recording and verifying system would utilize an electronic signaling technology such as Radio Frequency Identification (RFID) technology. In the most general sense, RFID systems include an interrogator, which typically employs an exciter that transmits a radio frequency excitation signal, and a transponder. The transponder is energized by the excitation signal to transmit a signal, including an identification code or other information, back to the interrogator. The transponder receives a radio frequency signal, or, more specifically, is energized by the radio frequency magnetic field and forms a response signal that will identify the transponder and which may provide additional information, and then transmits the response signal to the interrogator. The interrogator includes a receiver that receives the response signal and processes the information it contains. This information is then recorded by a data management system for access by the end user.

Radio frequency transponders are classified as either passive or active. Passive radio frequency transponders extract their power from the electromagnetic field provided by the interrogator, while an active radio frequency transponder includes a radio transceiver and a battery power source to enable it to transmit a signal to a remote receiver. The advantage to using active transponders is that they typically have increased range over passive transponders, but the disadvantage is that they require a battery power source to achieve that increased range.

While a variety of tracking and monitoring systems have been proposed in the past for different end applications which employ RFID capabilities, such systems have tended to be cumbersome, bulky and expensive. Also, none of the existing systems, to Applicant's knowledge, have been specifically directed to the problem of recording and verifying items of personal value which have been packed in a suitcase or piece of luggage used by a traveler in the course of a trip. While the existing RFID monitoring and tracking systems of the type discussed above may be useful in, for example, package shipment, fleet trucking, warehouse inventory, and the like, a need exists for a much simpler and economical alternative for use in tracking items of personal value packed in a suitcase or other item of luggage during periods of travel away from home.

### SUMMARY OF THE INVENTION

The present invention, briefly described, provides a method for recording and verifying the presence of an item of value in a piece of luggage by a traveler in the course of a trip. The steps of the method include positioning an interrogator unit on or within the piece of luggage. Each item of value has affixed thereto an electronic signaling chip or device which is capable of transmitting identifying information to the interrogator unit. Preferably, the interrogator unit has an exciter that transmits a radio frequency excitation signal. The preferred electronic signaling chip or device is an RFID tag is affixed to each item of value being packed by the traveler within the piece of luggage. Each RFID tag contains a transponder which is energized by the excitation signal to transmit a response signal which contains identifying information back to the interrogator. The interrogator is provided with a receiver that receives the response signal and processes the information it contains.

The interrogator unit is preferably located within an interior space of the piece of luggage. The preferred RFID tags are factory programmed with a unique set of identifying information which is readable by the interrogator unit so that the traveler does not have to program each tag. The tags can conveniently be provided in the form of a label having an adhesive backing which allows the label to be removably attached to the item of value.

A luggage monitoring system for holding and monitoring items of value by a traveler in the course of a trip away from home is also shown. The monitoring system includes a bag having an exterior and having an interior space. The interior space has an interrogator unit positioned therein, the interrogator unit having an exciter that transmits a radio frequency excitation signal. A plurality of RFID tags are also provided as a part of the monitoring system. At least selected ones of the items of value placed within the interior space of the bag have an RFID tag attached thereto. Each RFID tag contains a transponder which is energized by the excitation signal to transmit a response signal which contains identifying information back to the interrogator. The interrogator is provided with a receiver that receives the response signal and processes the information it contains. Preferably, the interrogator unit verifies the presence of each of the items of value which were initially tagged and placed within the interior of the bag. If an item is missing, the interrogator can initiate an alarm sequence to notify the traveler.

Additional objects, features and advantages will be apparent in the written description which follows.

### BRIEF DESCRIPTION OF THE DRAWINGS

FIG. 1 is a perspective view of a typical item of luggage, in this case a bag, which might be equipped with the tracking system of the invention, one corner of the bag being shown broken away to reveal an interrogator unit contained within the interior of the bag.

FIG. 2 is a simplified depiction of the transponder component of the tracking system of the invention;

FIG. 3 is a side, cross sectional view of a label employing the interrogator component of FIG. 3;

FIG. 4 is a perspective view of an item of value, in this case a cell phone, having an RFID label attached thereto which can be read by the interrogator unit;

FIG. 5 is a block diagram illustrating the operation of the transceiver component of the tracking system of the invention;

FIG. 6 is a block diagram, similar to FIG. 5, but showing the operation of the transponder component of the tracking system of the invention.

### DETAILED DESCRIPTION OF THE INVENTION

The present invention utilizes electronic signaling technology to monitor items of personal value packed within a bag or suitcase or other item of luggage by a traveler during a trip away from home. A number of different types of electronic signaling technologies can be envisioned which are within the scope of the present inventive concept. For example, Global Positioning System (GPS) chips, or other electronic signaling chips might be utilized in the practice of the present invention. The preferred electronic signaling chip or device to be described in terms of the preferred embodiment of the invention is an RFID chip. As discussed briefly in the Background section of the Specification, RFID systems are radio communication systems in which communication is provided between a radio transceiver, or interrogator, and a number of small, identifying labels or tags. The interrogator transmits to the tags using modulated radio signals, and the tags respond by transmitting modulated radio signals back to the interrogator. For example, the interrogator may first transmit an amplitude modulated signal to the tag. Next, the interrogator transmits a continuous-wave (CW) radio signal to the tag. The tag then modulates the CW signal wherein the antenna is electrically switched, by the tag's modulating signal, from being an absorber of radio frequency (RF) radiation to being a reflector of RF radiation; thereby encoding the tag's information onto the CW radio signal. The interrogator demodulates the incoming modulated radio signal and decodes the tag's information message.

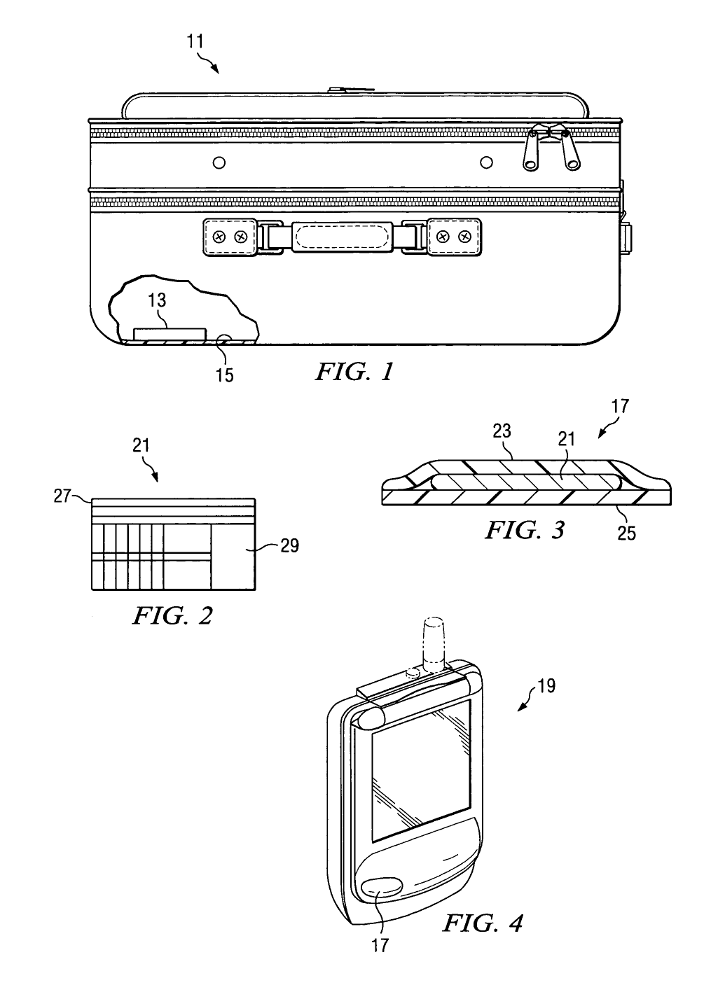

The preferred method of the present invention uses RFID technology for recording and verifying the presence of an item of value in a piece of luggage packed by a traveler in the course of a trip. FIG. 1 shows a piece of luggage, in this case a bag 11, which has an RFID interrogator 13 positioned within an interior space 15 of the bag 11. Preferably, the interrogator unit is removably attached to the bag interior as by mating Velcro® strips. Alternatively, the RFID interrogator can be sewn into the lining or otherwise affixed to either an interior or exterior surface of the bag. The interrogator can be commercially obtained and, in known fashion, comprises in part an exciter that transmits a radio frequency excitation signal.

The method of the invention also includes providing the traveler with a set of RFID tags 17. As shown in FIG. 4, at least selected ones of the traveler's items of personal value have an RFID tag affixed thereto. In the example shown in FIG. 4, the tag 17 is affixed to a cell phone 19. While the tag 17 is shown positioned on the front of the cell phone 19, it will be understood that it could have as easily been affixed to the rear of the phone, or even inside the lid or battery compartment. Each RFID tag 17 contains a transponder which is energized by the excitation signal to transmit a response signal which contains identifying information back to the interrogator unit 13.

The interrogator unit 13 is provided with a receiver that receives the response signal and processes the information it contains. In the preferred method of the invention, the traveler purchases the interrogator unit 13 and a set of preprogrammed tags 17. It is only necessary, at a minimum, that each tag be programmed with a unique identifying number. The interrogator would be capable of reading each unique identifying number as an item of value is placed within the bag interior 15 during packing and of storing the unique numbers in memory. The interrogator can then be turned off or placed in an active status.

Once the traveler is ready to leave for home, the interrogator is turned back on or placed in active status mode. As each item of value is returned to the bag interior, the interrogator registers or verifies that the item is present. If any item is missing at the time the interrogator is again turned off or again changes operational mode, an alarm would preferably be triggered. The alarm could take the form of an audible sound or could be a flashing LED, a vibrator, or other form of alarm mechanism.

FIG. 3 shows an RFID chip 21 which is sandwiched between upper and lower laminate layers 23, 25. Preferably, the lower laminate layer 25 has an adhesive backing, so that the RFID chip is provided in the form of a label which can be peeled apart and applied to an item of value to be marked. This would allow the labels to be removably attached to the item so that the label could be removed when it was no longer needed.

Preferably, the RFID tags are factory programmed with a unique set of identifying information which is readable by the interrogator unit so that the traveler does not have to program each tag. Alternatively, the RFID tags could be programmable by the traveler to include unique identifying information such as a home address or other personal identifying indicia.

The intelligent label of the preferred embodiment would include a surface to permit the printing or writing of information on the label, such as a name, shipping destination, package contents, or a bar code. Alternatively, an embodiment is envisioned whereby the label is purposely designed to be devoid of all markings, the intention of the designer to make the label blend with the surface to which it is attached. In yet another alternative, the label is transparent or semi-transparent, allowing all or part of the surface under the label to be visible through the label.

The laminate layers 23, 25 which form the substrate for the RFID chip could be fabricated utilizing standard material or any other material used to make labels. Additionally, it is envisioned that the substrate could be made from plastic, including polyester material, paper, synthetic paper, reinforced cardboard, synthetic paper coated cardboard, metal, or any other appropriate substance.

The radio frequency transponder chip 21 is embedded into the substrate or coupled to the substrate and preferably does not exceed the outer boundaries of the substrate. In one embodiment, portions of the radio frequency transponder are printed, while other portions are incorporated by other means. For example, antennas and wiring are prime candidates for printing, while it may be desired to attach the integrated circuits or portions of the integrated circuits separately because extremely tiny and thin circuit chips can be produced in high volume using automated techniques. In yet a third embodiment the radio frequency transponder is manufactured as a self contained unit and is attached to the substrate in a separate manufacturing operation. U.S. Pat. Nos. 6,107,920 and 6,280,544 provide examples of radio frequency transponders in combination with substrates and are incorporated by reference herein in their entirety.

FIG. 2 shows an unobstructed view of the radio frequency transponder chip 21. The transponder comprises an antenna 27 and an integrated circuit chip 29. If desired, a power source (not shown), such as a thin battery can be linked to the transponder to improve the transmission range of the transponder. The thin battery can be in the form of a printed battery such as one manufactured utilizing Texas Instrument's flexographic printed battery process. Additionally, the transponder could further include a memory for storing data. This memory could be in the form of a commercially available memory chip. An exemplary radio frequency transponder is the subject of U.S. Pat. No. 5,574,470, and is incorporated by reference herein in its entirety. An alternate exemplary radio frequency transmitter is the subject of U.S. Pat. No. 5,942,977 and is also incorporated by reference herein in its entirety. Yet another alternate exemplary radio frequency transmitter is the Motorola BiStatix inductive transmitter. However, the form of the transponder is not limited to these examples or similar examples. Likewise, the type of transponder is not limited to the specific embodiments described in the examples. It is envisioned that the transponder should be selected based on the needs of the end user for the particular luggage tracking task at hand. Such needs include signal range, speed of data transmittal, amount of data transmittal, frequency of data transmittal, or any special signal frequency or signal amplitude requirements.

Inductive RFID tags of the type under consideration consist of silicon, a coiled, etched, or stamped antenna, a capacitor, a substrate, and may include a protective covering as well as an encapsulating sealant. The recently introduced thin, planar inductive tags by Motorola sold under the “BiStatix” brand feature wire, printed silver, etched, or stamped metal antennae on flexible substrates. The reduction from several hundred turns of copper wire down to a half dozen turns of wire, printed silver etched or stamped metal coils and the elimination of a hard protective cover has substantially reduced tag cost. Electric fields are capacitively coupled to and from an interrogator or reader and a transponder. As in an inductive system, a BiStatix reader/writer generates an excitation field which serves as both the tag's source of power and its master clock. The tag cyclically modulates its data contents and transmits them to the reader's receiver circuit. The reader demodulates and decodes the data signal and provides a formatted data packet to a microprocessor for further processing. The BiStatix system provides a simple and cost effective tag design, suitable for high volume or disposable applications. By utilizing capacitive coupling, costly coils, capacitors, lead-frames, low resistance interconnects, and inflexible substrates can be eliminated.

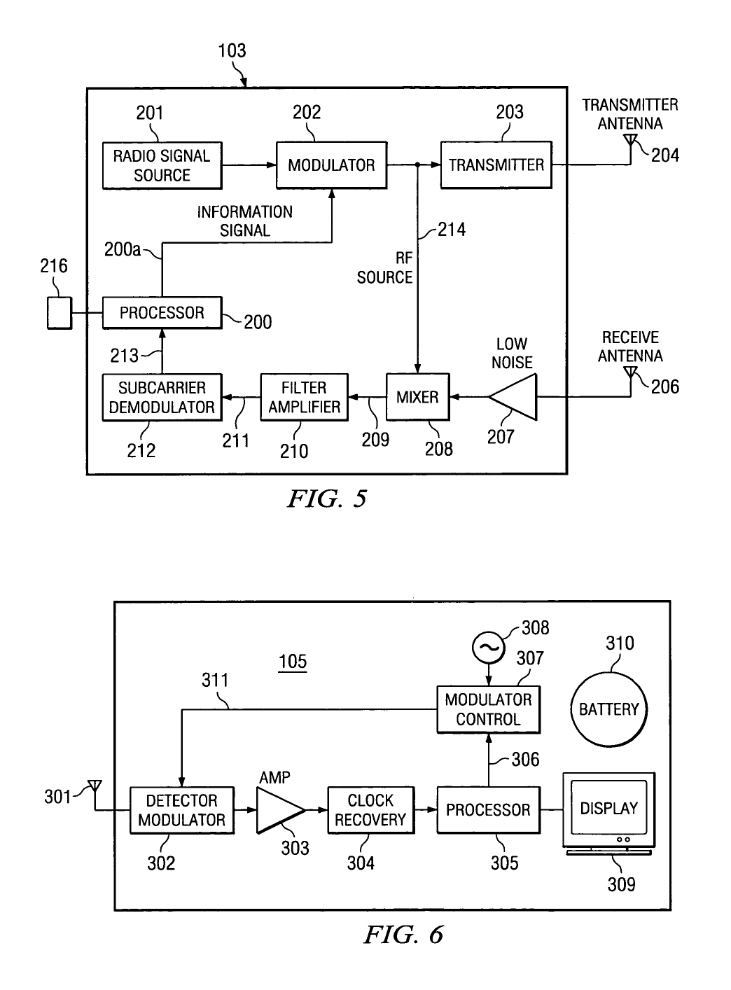

The workings of the RFID interrogator 13 and transponder chip 21 will now be explained with reference to FIGS. 5 and 6. The following description is not intended to be limiting up the invention, but is merely intended to provide general background information or the workings of a typical RFID interrogator/transponder system. Referring first to FIG. 5, there is shown a block diagram of an illustrative interrogator unit used in the radio frequency identification system of the invention. A radio signal source 201 generates a radio signal, the modulator 202 modulates an information signal 200a onto the radio signal, and a transmitter 203 sends this modulated signal via an antenna 204, illustratively using amplitude modulation, to a tag. Amplitude modulation is a common choice since a tag can demodulate such a signal with a single, inexpensive nonlinear device (such as a diode).

FIG. 6 shows a block diagram of a transponder tag unit usable in the radio frequency identification system of the invention. In the tag 105, the loop antenna 301 receives a modulated signal from the interrogator unit. This modulated signal is demodulated, directly to baseband, using a detector/modulator 302, which, illustratively, could be a single Schottky diode. The diode is appropriately biased with a proper current level in order to match the impedance of the diode and the antenna 301 so that losses of the radio signal are minimized. After the incoming signal is demodulated directly to baseband by the detector/modulator 302, the information signal is then amplified, by amplifier 303, and synchronization recovered in a clock and frame recovery circuit 304. The resulting information is sent to a processor 305.

The processor 305 generates an information signal 306 to be sent from the tag 105 back to the interrogator (e.g., 103). This information signal 306 (under control of the clock and frame recovery circuit 304) is sent to a modulator control circuit 307, which uses the information signal 306 to modulate a subcarrier frequency generated by the subcarrier frequency source 308. The modulated subcarrier signal 311 is used by detector/modulator 302 to modulate the radio carrier signal received from tag 105 to produce a modulated backscatter (e.g., reflected) signal. This is accomplished by switching on and off the Schottky diode using the modulated subcarrier signal 311, thereby changing the reflectance of antenna 301. Obtaining operating power for the tag 105 just from the incident RF energy is sufficient for most applications of the tag. As an option, operating power may also be obtained from an inexpensive power cell embedded in the tag.

The functions of the components in the tag 105 shown in FIG. 3 may advantageously be implemented in a single ASIC (Application Specific Integrated Circuit) which can be obtained from a number of suppliers such as, for example, Micron Technologies, RCA and Texas Instruments. As described above, a Shottky diode rectifier demodulates the received signal to baseband. Additional diodes and capacitors integrated into the ASIC substrate rectify the received RF energy to provide a DC voltage to energize the baseband processing circuit. A nonvolatile memory stores data which can be read from the tag as it passes through the field of the interrogator.

Returning once again to FIG. 5, the interrogator 103 receives the reflected and modulated signal with the receive antenna 206, amplifies the signal with a low noise amplifier 207, and demodulates the signal using homodyne detection in a mixer 208 down to the intermediate frequency (IF) of the single subcarrier. The mixer 208 sends a demodulated signal 209 into filter/amplifier 210 to properly filter the demodulated signal 209. The resulting filtered signal—then typically an information signal 211 carried on an IF subcarrier—is demodulated from the subcarrier in the subcarrier demodulator 212, which sends the information signal 213 to processor 200 to determine the content of the message. The I and Q channels of Signal 209 can be combined in the filter/amplifier 210, or in the subcarrier demodulator 212, or they could be combined in the processor 200.

A typical traveler might utilize the monitoring system of the invention in the following way. The interrogator unit 13, (FIG. 1) and a plurality of transponder “labels” 17, (FIG. 3) might be purchased in kit form. The traveler would affix the interrogator unit 13 to a bag 11 in some convenient fashion and then apply the labels to selected items of value to be taken on a trip. Alternatively, the interrogator is attached or sewn into the bag 11 at the factory by the manufacturer and the bag and a plurality of transponder tags or labels are provided to a consumer at the point of purchase.

The processor 200 in the interrogator unit 103 has a memory function which stores the identity data read from the plurality labels 17 in the manner described above as the traveler packs the bag 11. The interrogator is then typically switched off. At the arrival destination, the bag is unpacked and at least some of the items removed from the bag for use by the traveler. The interrogator unit 13 is again turned on when the trip is complete and the bag is being repacked by the traveler. As the marked items of value are returned to the bag 11, the identifying information contained on each tag is again read. The processor 200 is then commanded to compare the reentered information to the information contained in the memory of the processor. If any of the items are missing from the bag, the processor 200 triggers an alarm (216 in FIG. 5). The alarm could be in the form of an audible alarm or a visible alarm such as a lighted or flashing LED.

An invention as been provided with several advantages. The monitoring system of the invention provides a traveler with the peace of mind of knowing with certainty that all items of personal value have been packed for the return trip. Personal items of value will not be left behind inadvertently. It will not be necessary to have lost items identified by a third party or shipped to the proper owner. Because the interrogator function of the system need only read a unique identifying number, the electronics of the unit can be extremely simple. It is also not necessary that the user program the transponder chips in the preferred embodiment of the invention, since only a unique identifying number for each item to be marked is needed. The interrogator unit can be portable and can be moved from one item of luggage to another. The RFID tags can conveniently be provided as adhesive labels which can be easily applied and then removed from an item of value. If desired, the transponder memories can be programmed to contain more elaborate information, such as an owner's name, home address, telephone number and the like. The transponder tag could be read by a third party interrogator unit, which would allow a temporarily misplaced item to be identified and returned to its proper owner.

While the invention has been described with reference to only a limited number of embodiments, it will be appreciated that various changes and modifications can be made without departing from the scope of the invention which is limited only by the appended claims.

I claim:

1. A method for recording and verifying the presence of an item of value in a piece of luggage by a traveler in the course of a trip, the method comprising the steps of:
positioning an interrogator unit on or within the piece of luggage;
affixing an electronic signaling device to each item of value being packed by the traveler within the piece of luggage, each electronic signaling device having a signal transmitter capable of transmitting identifying information back to the interrogator; and
wherein the interrogator is provided with a receiver that receives the transmitted signal and processes the information it contains, the processed information serving to verify the presence of each tagged item of value within the piece of luggage.

2. The method of claim 1, wherein the interrogator unit has an exciter which transmits a radio frequency excitation signal and wherein the electronic signally devices are RFID tags which are placed on the items of value.

3. The method of claim 1, wherein the electronic signaling device is a GPS chip which is placed on each item of value to be verified and which transmits geographic identifying information to the interrogator unit.

4. A method for recording and verifying the presence of an item of value in a piece of luggage by a traveler in the course of a trip, the method comprising the steps of:
positioning an interrogator unit on or within the piece of luggage, the interrogator unit having an exciter that transmits a radio frequency excitation signal;
affixing an RFID tag to each item of value being packed by the traveler within the piece of luggage, each RFID tag containing a transponder which is energized by the excitation signal to transmit a response signal which contains identifying information back to the interrogator; and
wherein the interrogator is provided with a receiver that receives the response signal and processes the information it contains, the processed information serving to verify the presence of each tagged item of value within the piece of luggage.

5. The method of claim 4, wherein the interrogator unit is located within an interior space of the piece of luggage.

6. The method of claim 4, wherein the RFID tags are factory programmed with a unique set of identifying information which is readable by the interrogator unit so that the traveler does not have to program each tag.

7. The method of claim 4, wherein the RFID tags are programmable by the traveler to include unique identifying information.

8. The method of claim 4, wherein each RFID tag is provided in the form of a label having an adhesive backing which allows the label to be removably attached to an item of value.

9. A luggage monitoring system for holding and monitoring items of value by a traveler in the course of a trip away from home, the monitoring system comprising:
a bag having an exterior and having an interior space, the interior space having an interrogator unit positioned therein, the interrogator unit having an exciter that transmits a radio frequency excitation signal;
a plurality of RFID tags, at least selected ones of the items of value place within the interior space of the bag having an RFID tag attached thereto, each RFID tag containing a transponder which is energized by the excitation signal to transmit a response signal which contains identifying information back to the interrogator; and
wherein the interrogator is provided with a receiver that receives the response signal and processes the information it contains.

10. The system of claim 9, wherein the interrogator unit is located within an interior space of the piece of luggage.

11. The system of claim 9, wherein the RFID tags are factory programmed with a unique set of identifying information which is readable by the interrogator unit so that the traveler does not have to program each tag.

12. The system of claim 9, wherein the RFID tags are programmable by the traveler to include unique identifying information.

13. The method of claim 9, wherein each RFID tag is provided in the form of a label having an adhesive backing which allows the label to be removably attached to an item of value.
